(19) United States
(12) Patent Application Publication
(10) Pub. No.: US 2009/0119454 A1
(43) Pub. Date: May 7, 2009

(54) Method and Apparatus for Video Motion Process Optimization Using a Hierarchical Cache

(76) Inventor: Stephen John Brooks, Plainsboro, NJ (US)

Correspondence Address: Robert D. Shedd;Thomson Licensing LLC, PO Box 5312, PRINCETON, NJ, 08543-5312, US

(21) Appl. No.: 11/989,263

(22) PCT Filed: Jul. 27, 2006
(86) PCT No.: PCT/US2006/029719

§ 371 Date: Jan. 23, 2008

Related U.S. Application Data
(60) Provisional application No. 60/703,204, filed on Jul. 28, 2005.

(51) Int. Cl. G06F 12/08

(52) U.S. Cl. 711/118; 711/E12.017

(57) ABSTRACT

There are provided method and apparatus for video motion process optimization using a hierarchical cache. A storage method for a video motion process includes configuring a hierarchical cache to have one or more levels, each of the levels of the hierarchical cache corresponding to a respective one of a plurality of levels of a calculation hierarchy associated with calculating sample values for the video motion process. The method also includes storing a particular value for a sample relating to the video motion process in a corresponding level of the hierarchical cache based on which of the plurality of levels of the calculation hierarchy the particular value corresponds to, when the particular value is non-existent in the hierarchical cache.

### CROSS-REFERENCE TO RELATED APPLICATIONS

This application claims the benefit of U.S. Provisional Application Ser. No. 60/703,204, filed Jul. 28, 2005 and entitled “METHOD AND APPARATUS FOR VIDEO MOTION COMPENSATION,” which is incorporated by reference herein in its entirety.

### FIELD OF THE INVENTION

The present invention relates generally to video encoding and decoding and, more particularly, to methods and apparatus for video motion process optimization using a hierarchical sample cache.

### BACKGROUND OF THE INVENTION

For many video encoder/decoder applications, motion estimation and compensation is the main performance bottleneck. Statistically, the calculations used to generate resultant luma or chroma samples may be redundant due to space-time correlations in the motion compensation/estimation algorithms used to select a resultant sample. In video systems with sufficient memory resources, these samples can be cached thereby avoiding the redundant calculations and saving execution time.

Much of the effort to optimize motion compensation/estimation is focused on the optimization of the code which calculates necessary samples. This practice does not remove the redundant calculations from the program flow.

A description will now be given of the luma sample interpolation process of the International Organization for Standardization/International Electrotechnical Commission (ISO/IEC) Moving Picture Experts Group-4 (MPEG-4) Part 10 Advanced Video Coding (AVC) standard/international Telecommunication Union, Telecommunication Sector (ITU-T) H.264 standard (hereinafter the “MPEG4/H.264 standard” or simply the “H.264 standard”), to illustrate some of the redundancy in the luma sample interpolation process.

The H.264 standard utilizes a quarter-pixel (quarter-pel) interpolation scheme. FIG. 1 shows how these samples are laid out. Turning to FIG. 1, a diagram showing integer sample positions and fractional sample positions for quarter sample luma interpolation in accordance with the H.264 standard is indicated generally by the reference numeral 100. The integer sample positions are indicated by the blocks that are empty or that include upper-case letters, and the fractional sample positions are indicated by the blocks that include lower-case letters.

Sub-pixel (sub-pel) samples are calculated from the samples that lie on integer coordinates as follows (taken from section 8.4.2.2.1 of the H.264 standard):
Given the luma samples ‘A’ to ‘U’ . . . , the luma samples ‘a’ to ‘s’ at fractional sample positions are derived by the following rules. The luma prediction values at half sample positions shall be derived by applying a 6-tap filter with tap values (1, −5, 20, 20, −5, 1). The luma prediction values at quarter sample positions shall be derived by averaging samples at full and half sample positions. The process for each fractional position is described below.
   The samples at half sample positions labelled b shall be derived by first calculating intermediate values denoted as b₁ by applying the 6-tap filter to the nearest integer position samples in the horizontal direction. The samples at half sample positions labelled h shall be derived by first calculating intermediate values denoted as h₁ by applying the 6-tap filter to the nearest integer position samples in the vertical direction:

b₁=(E−5*F+20*G+20*H−5*I+J)

h₁=(A−5*C+20*G+20*M−5*R+T)
The final prediction values b and h shall be derived using:

b=Clip1_{Y}((b₁+16)>>5)

h=Clip1_{Y}((h₁+16)>>5)
The samples at half sample position labelled as j shall be derived by first calculating intermediate value denoted as j₁ by applying the 6-tap filter to the intermediate values of the closest half sample positions in either the horizontal or vertical direction because these yield an equal result.

j₁=cc−5*dd+20*h₁+20*m₁−5*ee+ff, or

j₁=aa−5*bb+20*b₁+20*s₁−5*gg+hh
where intermediate values denoted as aa, bb, gg, s₁ and hh shall be derived by applying the 6-tap filter horizontally in the same manner as the derivation of b₁ and intermediate values denoted as cc, dd, ee, m₁ and ff shall be derived by applying the 6-tap filter vertically in the same manner as the derivation of h₁. The final prediction value j shall be derived using:

J=Clip1_{Y}((j₁+512)>>10)
The final prediction values s and m shall be derived from s₁ and m₁ in the same manner as the derivation of b and h, as given by:

s=Clip1_{Y}((s₁+16)>>5)

m=Clip1_{Y}((m₁+16)>>5)
The samples at quarter sample positions labelled as a, c, d, n, f, i, k, and q shall be derived by averaging with upward rounding of the two nearest samples at integer and half sample positions using:

a=(G+b+1)>>1

c=(H+b+1)>>1

d=(G+h+1)>>1

n=(M+h+1)>>1

f=(b+j+1)>>1

i=(h+j+1)>>1

k=(j+m+1)>>1

q=(j+s+1)>>1.
The samples at quarter sample positions labelled as e, g, p, and r shall be derived by averaging with upward rounding of the two nearest samples at half sample positions in the diagonal direction using

e=(b+h+1)>>1

g=(b+m+1)>>1

p=(h+s+1)>>1

r=(m+s+1)>>1.
Note that Clip1_{Y} is an operation that clamps a number to 0, if less than 0, or to 255, if greater than 255, otherwise the number is passed through unchanged.

### SUMMARY OF THE INVENTION

These and other drawbacks and disadvantages of the prior art are addressed by the present invention, which is directed to methods and apparatus for video motion process optimization using a hierarchical sample cache.

According to an aspect of the present invention, there is provided a storage method for a video motion process. The method includes configuring a hierarchical cache to have one or more levels, each of the levels of the hierarchical cache corresponding to a respective one of a plurality of levels of a calculation hierarchy associated with calculating sample values for the video motion process. The method also includes storing a particular value for a sample relating to the video motion process in a corresponding level of the hierarchical cache based on which of the plurality of levels of the calculation hierarchy the particular value corresponds to, when the particular value is non-existent in the hierarchical cache.

According to another aspect of the present invention, there is provided an apparatus for supporting a video motion process. The apparatus includes a hierarchical cache configured to have one or more levels, each of the levels of the hierarchical cache corresponding to a respective one of a plurality of levels of a calculation hierarchy associated with calculating sample values for the video motion process. The hierarchical cache stores a particular value for a sample relating to the video motion process in a corresponding level of the hierarchical cache based on which of the plurality of levels of the calculation hierarchy the particular value corresponds to, when the particular value is non-existent in the hierarchical cache.

These and other aspects, features and advantages of the present invention will become apparent from the following detailed description of exemplary embodiments, which is to be read in connection with the accompanying drawings.

### BRIEF DESCRIPTION OF THE DRAWINGS

The present invention may be better understood in accordance with the following exemplary figures, in which:

FIG. 1 is a diagram showing integer sample positions and fractional sample positions for quarter sample luma interpolation, in accordance with the H.264 standard;

FIG. 2 is a block diagram for an exemplary video encoder to which the present principles may be applied, in accordance with an embodiment of the present principles;

FIG. 3 is a block diagram for an exemplary video decoder to which the present principles may be applied, in accordance with an embodiment of the present principles;

FIG. 4 is a diagram for a 1×1 block showing the locations of quarter-pel luma sample types therein, in accordance with an embodiment of the present principles;

FIG. 5 is a block diagram showing dependency relationships among sample types for the 1×1 block shown in FIG. 4; and

FIG. 6 is a flow diagram for an exemplary method for caching samples for a video motion process, in accordance with an embodiment of the present principles.

### DETAILED DESCRIPTION

The present invention is directed to methods and apparatus for video motion process optimization using a hierarchical sample cache. Advantageously, the method and apparatus in accordance with the present principles eliminates the redundant calculations performed during a video motion process such as, e.g., a block-based motion compensation and/or block-based motion estimation process.

It is to be appreciated that the present invention is not limited to any particular video encoding/decoding standard/technology and, thus, any video encoding/decoding standard/technology, as readily determined by one of ordinary skill in this and related arts, may be utilized in accordance with the present principles, while maintaining the scope of the present invention. It is to be further appreciated that a hierarchical cache in accordance with the present principles may be implemented in hardware and/or software. Moreover, implementations of a hierarchical cache in accordance with the present principles may involve one or more hierarchical caches.

This description illustrates the principles of the present invention. It will thus be appreciated that those skilled in the art will be able to devise various arrangements that, although not explicitly described or shown herein, embody the principles of the invention and are included within its spirit and scope.

All examples and conditional language recited herein are intended for pedagogical purposes to aid the reader in understanding the principles of the invention and the concepts contributed by the inventor to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

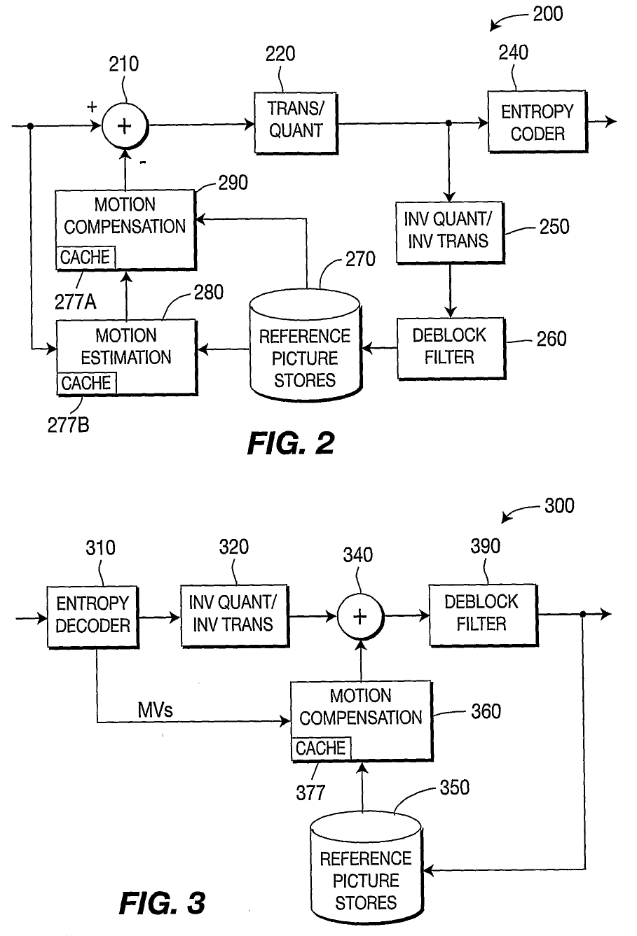

Turning to FIG. 2, an exemplary video encoder is indicated generally by the reference numeral 200. An input to the video encoder 200 is connected in signal communication with a non-inverting input of a summing junction 210. The output of the summing junction 210 is connected in signal communication with a transformer/quantizer 220. The output of the transformer/quantizer 220 is connected in signal communication with an entropy coder 240. An output of the entropy coder 240 is available as an output of the encoder 200.

The output of the transformer/quantizer 220 is further connected in signal communication with an inverse transformer/quantizer 250. An output of the inverse transformer/quantizer 250 is connected in signal communication with an input of a deblock filter 260. An output of the deblock filter 260 is connected in signal communication with reference picture stores 270. A first output of the reference picture stores 270 is connected in signal communication with a first input of a motion estimator 280. The input to the encoder 200 is further connected in signal communication with a second input of the motion estimator 280. The output of the motion estimator 280 is connected in signal communication with a first input of a motion compensator 290. A second output of the reference picture stores 270 is connected in signal communication with a second input of the motion compensator 290. The output of the motion compensator 290 is connected in signal communication with an inverting input of the summing junction 210.

In accordance with the principles associated with the instant embodiment, a hierarchical cache 277A is provided in the motion compensator 290 and a hierarchical cache 277B is provided in the motion estimator 280. It is to be appreciated that while separate caches are shown included in the motion compensator 290 and the motion estimator 280, in other embodiments, a single cache may be utilized by both the motion compensator 290 and the motion estimator 280, or more than one cache may be used in the motion compensator 290 and/or the motion estimator 290. That is, given the teachings of the present invention provided herein, one of ordinary skill in this and related arts will contemplate these and various other configurations of a hierarchical cache system for use for block-based motion estimation and/or motion compensation processes, while maintaining the scope of the present invention.

Turning to FIG. 3, an exemplary video decoder is indicated generally by the reference numeral 300. The video decoder 300 includes an entropy decoder 310 for receiving a video sequence. A first output of the entropy decoder 310 is connected in signal communication with an input of an inverse quantizer/transformer 320. An output of the inverse quantizer/transformer 320 is connected in signal communication with a first input of a summing junction 340.

The output of the summing junction 340 is connected in signal communication with a deblock filter 390. An output of the deblock filter 390 is connected in signal communication with reference picture stores 350. The reference picture stores 350 is connected in signal communication with a first input of a motion compensator 360. An output of the motion compensator 360 is connected in signal communication with a second input of the summing junction 340. A second output of the entropy decoder 310 is connected in signal communication with a second input of the motion compensator 360. The output of the deblock filter 390 is available as an output of the video decoder 300.

In accordance with the principles associated with the instant embodiment, a hierarchical cache 377A is provided in the motion compensator 360. It is to be appreciated that while a single cache is shown included in the motion compensator 360, in other embodiments, more than one cache may be included in the motion compensator 360. That is, given the teachings of the present invention provided herein, one of ordinary skill in this and related arts will contemplate these and various other configurations of a hierarchical cache system for use for block-based motion estimation and/or motion compensation processes, while maintaining the scope of the present invention.

As noted above, methods and apparatus are provided for block-based video motion estimation/compensation optimization using a hierarchical sample cache. Advantageously, the number of redundant calculations at runtime in a block-based motion compensation and/or motion estimation process may be reduced in accordance with the teachings of the present principles.

As described above, in block-based motion compensation/estimation, the calculation of an interpolated sample depends on other source samples. These source samples may be intermediary in nature and, if so, they would be calculated before the final resultant sample can be calculated. Thus, there is a hierarchical relationship among resultant samples.

For example, in the H.264 video standard, a resultant luma sample may be calculated by applying a six-tap Finite Impulse Response (FIR) filter to horizontally or vertically adjacent luma samples included in a reference frame. With coefficients of 1, −5, 20, 20, −5, and 1, this FIR filter uses 4 multiply operations and 5 addition operations. It is to be noted that this description does not account for rounding and shifting operations as they are not part of the FIR filter proper. Thus, the FIR filter is a relatively complex (costly) interpolation mechanism. Accordingly, the elimination of the redundant use of this FIR filter would improve performance. Additionally, there are cases when the inputs to this FIR filter are intermediary samples themselves, each of the inputs to this FIR filter being the output of this or another FIR filter. This increases the complexity by an order of magnitude, filtering the outputs of (possibly) six different filter applications to the samples. If each of the six samples fed to this final FIR filter had to be calculated, there would be a total of 28 multiply operations and 35 addition operations. Thus, even greater performance gains would be realized by removing redundant computations involving this double filtering.

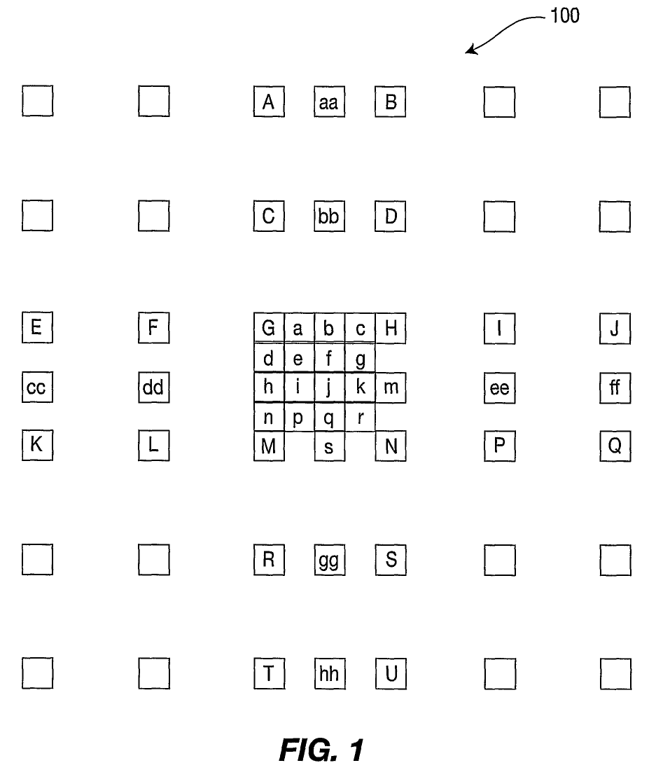

Thus, referring again to FIG. 1, it can be seen that there is a hierarchical relationship among the interpolated luma samples. The samples represented by b and h (which include s and m, respectively) are dependent on the luma samples at integer positions which come from the reference frame. Samples represented by j are dependent on (six) samples of the type represented by b or h. Samples represented by a and c are dependent on samples represented by b and an integer-positioned sample. Samples represented by d and n are dependent on samples represented by h and an integer-position sample. Samples represented by f, i, k, and q are dependent on samples represented by b, h, m, s, respectively, and samples represented by j. Finally, samples represented by e, g, p, and r are dependent on samples represented by j and integer-positioned samples represented by G, H, M, and N, respectively.

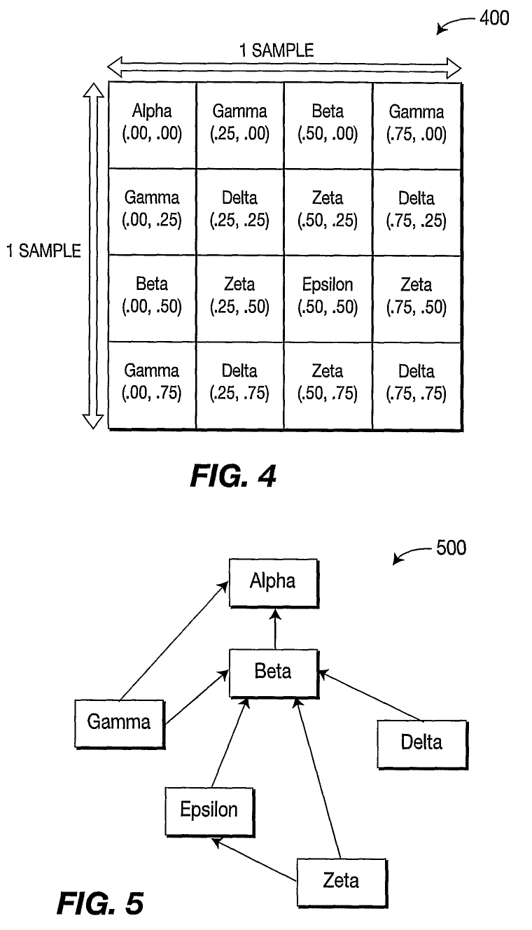

These relationships are tiers of a hierarchy. For reference purposes these tiers shall be given names. Turning to FIG. 4, 1×1 block showing the locations of quarter-pel luma sample types therein is indicated generally by the reference numeral 400. The location marked Alpha is the integer-positioned sample found in the reference frame. The fraction portions of the locations coordinates are in parentheses. Integer-positioned samples (which come from the reference frame) are hereby referred to as alpha samples. Samples represented by b and h are referred to as beta samples. Samples represented by a, c, d, and n are referred to as gamma samples. Samples represented by e, g, p, and r are referred to as delta samples. Samples represented by j are referred to as epsilon samples. Lastly, samples represented by f, i, k, and q are referred to as zeta samples. A cache sublevel may be named by the type of sample it holds, i.e., the beta sub-cache holds beta samples. The relative computational cost of each level increases from beta samples to zeta samples. It is to be appreciated that the terms “sub-cache” and “level” (as in a level in the hierarchical cache) are used interchangeably herein.

As can be inferred from above, a beta sample is derived from two alpha samples, a gamma sample is derived from one alpha sample and one beta sample, a delta sample is derived from two beta samples, an epsilon sample is derived from 6 beta samples, and a zeta sample is derived from one epsilon sample and one beta sample. Turning to FIG. 5, dependency relationships among sample types for the 1×1 block shown in FIG. 4 is indicated generally by the reference numeral 500.

A further breakdown is used within the scheme associated with the instant embodiment. The beta sub-cache (or beta level) has two members with different fractional coordinates. Likewise, the gamma, delta, and zeta levels have four samples each. To distinguish among samples of the same type, the fractional coordinates are called out. For example, the beta samples are may be referred to as beta (0.50, 0.00) and beta (0.00, 0.50).

A hierarchical cache can take advantage of these relationships by storing intermediate results from the interpolation process for a particular sample and returning those results as needed, saving the expense of having to re-perform some of the necessary calculations to compute that sample. For example (again referring to FIG. 1 above), sample a, a gamma (0.25, 0.00) sample, depends on sample b, a beta (0.50, 0.00) sample, being available (as well as a pixel from the reference frame). If sample a is needed and not in the cache's gamma (0.25, 0.00) level, sample a must be calculated and added to the cache. As part of computing a, b is required. If b is in the beta (0.50, 0.00) cache, then the beta (0.50, 0.00) cache forwards b, thereby speeding up the calculation of a. If b is not in the beta (0.50, 0.00) cache, b is calculated and placed in that cache, then forwarded so a can be computed. When a is calculated it is cached at the gamma (0.25, 0.00) level.

A description will now be given regarding static and dynamic caches, in accordance with various exemplary embodiments of the present principles.

In an embodiment of the present principles involving the H.264 standard, there are 15 total levels (sub-caches) possible in the cache: 2 beta; 4 delta; 4 gamma; 1 epsilon; and 4 zeta levels. A hierarchical sample cache may or may not include all 15 levels. For example, a cache might have only beta and epsilon sub-caches implemented in it. Similarly, a cache may not include all levels of a given tier; that is, a cache may only have zeta (0.25, 0.50) and zeta (0.50, 0.25) sub-caches and not all four zeta subtypes. Since there is memory and computation overhead in employing a sample cache, this allows the utilization of memory and computation resources to be utilized most efficiently for a particular decoding environment. A large amount of available memory could afford the usage of more sub-caches. If memory is at a premium, perhaps only one or two sub-caches are used. Moreover, it is to be appreciated that the one or more of the 15 levels may be implemented as stand-alone caches and not sub-caches. These and various other implementations and configurations of the present principles are readily contemplated by one of ordinary skill in this and related arts, given the teachings of the present principles provided herein.

A static cache in accordance with the present principles is one in which the levels of the hierarchy are fixed. If the resources in a particular encoding and/or decoding environment available to sample caching remain fairly rigid, the static cache places no additional sub-cache management overhead on the system. A dynamic cache in accordance with the present principles is one in which sub-caches may be added or removed. The addition and/or removal of sub-caches may be determined by criteria evaluated outside the cache. A dynamic cache can make use of and adapt to the varying availability of resources. As more memory and/or computing power becomes available, a sub-cache may be added. Conversely, as these resources dwindle, sub-caches may be removed, lessening the demand of the cache in whole. Resources are not the only criteria upon which sub-cache management decisions are made. For example, an encoder and/or decoder of sufficient complexity may find (or be informed) that all interpolation is performed on half-pel coordinates. This would mean only beta and epsilon samples would be used, making the beta and epsilon sub-caches the only levels practical for use (refer to the locations of beta and epsilon samples in FIG. 4).

A description will now be given regarding cache content, in accordance with an exemplary embodiment of the present principles.

The cache is an array of luma samples interpolated from reference content via the mechanisms prescribed by the block-based motion compensation process for a particular video decoder specification. These operations are usually relatively expensive. The cache holds these values to avoid their redundant calculation. The precision at which the samples are stored in the cache may not be the precision of the final result. For example, in H.264 decoding the sample cache holds the luma value calculated by applying a six-tap filter to a set of input samples. Luma samples in H.264 are frequently 8 bits. In the calculation of the epsilon sample, seven six-tap filter applications are made. The first six are performed on six rows (or columns) of six alpha samples from the reference frame to produce a column (or row) of beta samples. These six input beta samples are not rounded and clipped to 8-bit precision, but are rather kept in their original precision when the seventh six-tap application is performed on them. The result of this final filter application is then rounded and clipped to yield the epsilon sample. (This process is indicated in the H.264 specification excerpt above). A beta sub-cache which held its samples at this higher intermediate precision would be necessary since samples rounded and clipped to final precision cannot be used to calculate epsilon samples. However, if the decoder can know that epsilon samples are never produced (thus neither are zeta samples), then the beta sub-cache would not need to hold intermediate precision samples; the beta sub-cache could hold samples at final (smaller) precision, perhaps lessening the memory requirements.

A description will now be given regarding cache access, in accordance with an exemplary embodiment of the present invention.

In block-based motion compensation, motion vectors describe the prior location of a block being decoded relative to the current location of that block. The motion vector is added to the position of the current block to yield the reference location for the desired sample. Cache access is made by that location. A sample at (X.x, Y.y) (where X and Y denote the integer portion of the coordinate and x and y the fractional portion) has a distinct location in the sample cache. The fractional portions, x and y, of the coordinates determine which sub-cache holds the sample (see FIG. 4). A sample at reference location (10.50, 8.00) is a sample of type beta (0.50, 0.00) and would be in that sub-cache if available. The integer portions, X and Y, of the coordinates give the location of the sample within the sub-cache. Anytime a sample is required its reference location is given to the cache and the cache either returns the result or indicates that the sample is not in the cache.

Possible parameters that may be affected by the use of a cache in accordance with the present principles include/involve: memory resources (in terms of main memory bandwidth usage, main memory size usage, code size, and effect on processor caches, if any) and the computational bandwidth (CPU time) consumed by the code which implements the cache. It is to be appreciated that not all levels of the hierarchy need to be implemented to see performance gains so the memory usage demanded by an application employing such a cache can be throttled either at run-time (dynamic) or at build-time (static). Moreover, multiple caches may be used by an application to increase performance further, at the cost of increased resource usage. Given the teachings of the present invention provided herein, one of ordinary skill in this and related art will contemplate these and various other implementations and configurations of a hierarchical cache for block-based motion compensation/estimation, while maintaining the scope of the present invention.

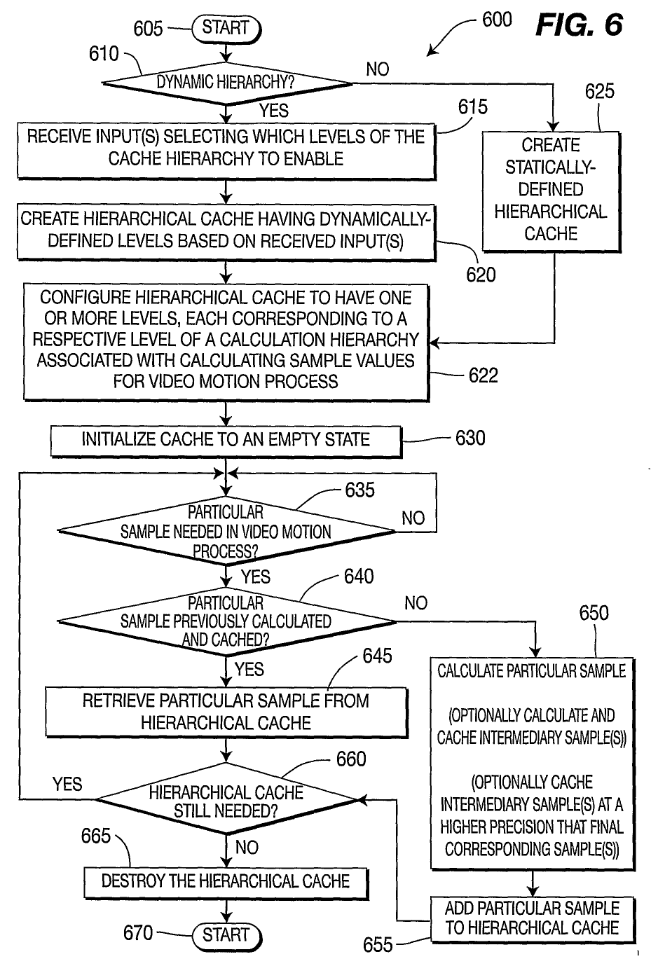

Turning to FIG. 6, a method for caching samples for a video motion process is indicated generally by the reference numeral 600. The video motion process may be, e.g., a block-based motion compensation process and/or a block-based motion estimation process.

The method 600 includes a start block 605 that passes control to a decision block 610. The decision block 610 determines whether or not a dynamic hierarchy-level selection has been implemented. If so, control is passed to a function block 615. Otherwise, control is passed to a function block 625.

The function block 615 receives one or more inputs selecting which levels of the cache hierarchy to enable, and passes control to a function block 620. The function block 620 creates a hierarchical cache having the levels dynamically-defined by the one or more inputs received by the function block 615, and passes control to a function block 622.

The function block 625 creates a statically-defined hierarchical cache, and passes control to the function block 622.

The function block 622 configures the hierarchical cache to have one or more levels, each corresponding to a respective one of a plurality of levels of a calculation hierarchy associated with calculating sample values for the video motion process, and passes control to a function block 630. That is, the hierarchical cache is created so that the levels of the cache relate to or are otherwise correlated with levels in the hierarchical relationship between resultant samples of the video motion process. It is to be appreciated that while the configuration function performed by function block 622 is shown separate from the creation function of function blocks 620 and 625, the configuration function may be considered to be part of the creation function.

The function block 630 initializes the cache to an empty state in which no samples have been stored, and passes control to a decision block 635.

The decision block 635 determines whether or not a particular sample is needed in the video motion process. If so, then control is passed to a decision block 640. Otherwise, control is returned to the function block 635.

The decision block 640 checks the appropriate level of the cache to determine whether or not the particular sample was previously calculated and cached. If so, then control is passed to a function block 645. Otherwise, control is passed to a function block 650.

S The function block 645 retrieves the particular sample from the cache, and passes control to a decision block 660. It is to be appreciated that the particular sample may be retrieved from the cache based on an integer portion and a fractional portion of a location corresponding to a reference frame.

The function block 650, calculates the particular sample (which may require calculating and caching one or more intermediary samples), and passes control to a function block 655. It is to be appreciated that the function block 650 may cache the intermediary samples at a higher precision than the final sample corresponding thereto. For example, the intermediary samples may be stored at a higher resolution, a higher frame rate, and/or a higher bit rate than that of the final sample. The function block 655 adds the particular sample calculated by the function block 650 to the cache, and passes control to the decision block 660.

The decision block 660 determines whether or not the cache is (still) needed. If so, then control is returned to the function block 635. Otherwise, control is passed to a function block 665. The function block 665 destroys the cache (e.g., memory resources consumed/utilized by the cache are released, and so forth), and passes control to an end block 670.

Further regarding the correlation between the levels of the hierarchical cache with the hierarchical relationship between resultant samples of the block-based motion compensation/estimation process, an example will now be described for illustrative purposes. For example, in the H.264 standard, required samples which have a fractional coordinate equal to 0.5 must be interpolated from samples which have a fractional coordinate of 0.0. Required samples which have a fractional coordinate equal to 0.25 or 0.75 must be interpolated from at least one sample which has a fractional coordinate of 0.5. Section 8.4.2.2.1 of the H.264 standard describes the normative relationship. Given the teachings of the present principles provided herein, one of ordinary skill in this and related arts will contemplate this and other ways in which the levels of the hierarchical cache are related or otherwise correlated with resultant samples of a block-based motion compensation/estimation process, while maintaining the scope of the present invention.

Further regarding the configuring of the cache, such configuring may involve configuring the hierarchical structure of the cache, configuring the block-based motion compensation and/or estimation process itself, configuring the memory hierarchy of the system on which the present principles are implemented to use the cache for at least some operations of the motion compensation and/or estimation process, and so forth. Such details are readily determined by one of ordinary skill in this and related arts and are, thus, omitted herein for the sake of brevity.

A description will now be given of some of the many attendant advantages/features of the present invention, some of which have been mentioned above. For example, one advantage/feature is a storage method for a video motion process, wherein the storage method includes configuring a hierarchical cache to have one or more levels, each of the levels of the hierarchical cache corresponding to a respective one of a plurality of levels of a calculation hierarchy associated with calculating sample values for the video motion process. The storage method further includes storing a particular value for a sample relating to the video motion process in a corresponding level of the hierarchical cache based on which of the plurality of levels of the calculation hierarchy the particular value corresponds to, when the particular value is non-existent in the hierarchical cache. Another advantage/feature is the storage method as described above, wherein the video motion process includes a block-based motion compensation process. Moreover, another advantage/feature is the storage method as described above, wherein the method further includes retrieving the particular value for the sample from the corresponding level of the hierarchical cache, when the particular sample exists in the hierarchical cache. Further, another advantage/feature is the storage method as described above, wherein the method further includes storing an intermediate value for the sample for subsequent use in calculating the particular value for the sample in a corresponding level of the hierarchical cache based on which of the plurality of levels of the calculation hierarchy the intermediate value corresponds to, when the intermediate value is non-existent in the hierarchical cache. Also, another advantage/feature is the storage method that stores an intermediate value for the sample as described above, wherein the particular value is a final value for the sample, and the intermediary value is stored at a higher precision than the particular value. Additionally, another advantage/feature is the storage method that stores an intermediate value for the sample wherein the particular value is a final value for the sample as described above, and wherein the higher precision relates to at least one of a higher resolution, a higher frame rate, and a higher bit rate than the final sample. Moreover, another advantage/feature is the storage method as described above, wherein the configuring step configures the hierarchical cache to have a statically defined hierarchy such that the one or more levels of the hierarchical cache are fixed. Further, another advantage/feature is the storage method as described above, wherein the configuring step configures the hierarchical cache to have a dynamically defined hierarchy such that any of the one or more levels already existing are capable of being removed and one or more new levels are capable of being added thereto. Also, another advantage/feature is the storage method that configures the hierarchical cache to have a dynamically defined hierarchy as described above, wherein particular levels of the dynamically-defined hierarchy are dynamically enabled in response to user inputs. Additionally, another advantage/feature is the storage method as described above, wherein the method further includes receiving one or more user inputs relating to which of the one or more levels of the hierarchical cache are to be enabled for a current execution of the video motion process. Moreover, another advantage/feature is the storage method as described above, wherein the method further includes accessing the hierarchical cache based on an integer portion and a fractional portion of a location corresponding to a reference frame used for the video motion process. Further, another advantage/feature is the storage method as described above, wherein the hierarchical cache is implemented in software.

These and other features and advantages of the present invention may be readily ascertained by one of ordinary skill in the pertinent art based on the teachings herein. It is to be understood that the teachings of the present invention may be implemented in various forms of hardware, software, firmware, special purpose processors, or combinations thereof.

Most preferably, the teachings of the present invention are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present invention is programmed. Given the teachings herein, one of ordinary skill in the pertinent art will be able to contemplate these and similar implementations or configurations of the present invention.

Although the illustrative embodiments have been described herein with reference to the accompanying drawings, it is to be understood that the present invention is not limited to those precise embodiments, and that various changes and modifications may be effected therein by one of ordinary skill in the pertinent art without departing from the scope or spirit of the present invention. All such changes and modifications are intended to be included within the scope of the present invention as set forth in the appended claims.

1. A storage method for a video motion process, comprising:
configuring a hierarchical cache to have one or more levels, each of the levels of the hierarchical cache corresponding to a respective o ne of a plurality of levels of a calculation hierarchy associated with calculating sample values for the video motion process; and
storing a particular value for a sample relating to the video motion process in a corresponding level of the hierarchical cache based on which of the plurality of levels of the calculation hierarchy the particular value corresponds to, when the particular value is non-existent in the hierarchical cache.

2. The method of claim 1, wherein the video motion process includes a block-based motion compensation process.

3. The method of claim 1, further comprising retrieving the particular value for the sample from the corresponding level of the hierarchical cache, when the particular sample exists in the hierarchical cache.

4. The method of claim 1, further comprising storing an intermediate value for the sample for subsequent use in calculating the particular value for the sample in a corresponding level of the hierarchical cache based on which of the plurality of levels of the calculation hierarchy the intermediate value corresponds to, when the intermediate value is non-existent in the hierarchical cache.

5. The method of claim 4, wherein the particular value is a final value for the sample, and the intermediary value is stored at a higher precision than the particular value.

6. The method of claim 5, wherein the higher precision relates to at least one of a higher resolution, a higher frame rate, and a higher bit rate than the final sample.

7. The method of claim 1, wherein said configuring step configures the hierarchical cache to have a statically defined hierarchy such that the one or more levels of the hierarchical cache are fixed.

8. The method of claim 1, wherein said configuring step configures the hierarchical cache to have a dynamically defined hierarchy such that any of the one or more levels already existing are capable of being removed and one or more new levels are capable of being added thereto.

9. The method of claim 8, wherein particular levels of the dynamically-defined hierarchy are dynamically enabled in response to user inputs.

10. The method of claim 1, further comprising receiving one or more user inputs relating to which of the one or more levels of the hierarchical cache are to be enabled for a current execution of the video motion process.

11. The method of claim 1, further comprising accessing the hierarchical cache based on an integer portion and a fractional portion of a location corresponding to a reference frame used for the video motion process.

12. The method of claim 1, wherein the hierarchical cache is implemented in software.

13. An apparatus for supporting a video motion process, comprising:
a hierarchical cache configured to have one or more levels, each of the levels of the hierarchical cache corresponding to a respective one of a plurality of levels of a calculation hierarchy associated with calculating sample values for the video motion process, the hierarchical cache for storing a particular value for a sample relating to the video motion process in a corresponding level of the hierarchical cache based on which of the plurality of levels of the calculation hierarchy the particular value corresponds to, when the particular value is non-existent in the hierarchical cache.

14. The apparatus of claim 13, wherein the video motion process includes a block-based motion compensation process.

15. The apparatus of claim 13, wherein said hierarchical cache retrieves the particular value for the sample from the corresponding level of the hierarchical cache, when the particular sample exists in the hierarchical cache.

16. The apparatus of claim 13, wherein said hierarchical cache stores an intermediate value for the sample for subsequent use in calculating the particular value for the sample in a corresponding level of the hierarchical cache based on which of the plurality of levels of the calculation hierarchy the intermediate value corresponds to, when the intermediate value is non-existent in the hierarchical cache.

17. The apparatus of claim 16, wherein the particular value is a final value for the sample, and the intermediary value is stored at a higher precision than the particular value.

18. The apparatus of claim 17, wherein the higher precision relates to at least one of a higher resolution, a higher frame rate, and a higher bit rate than the final sample.

19. The apparatus of claim 13, wherein said hierarchical cache is configured to have a statically defined hierarchy such that the one or more levels of the hierarchical cache are fixed.

20. The apparatus of claim 13, wherein said hierarchical cache is configured to have a dynamically defined hierarchy such that any of the one or more levels already existing are capable of being removed and one or more new levels are capable of being added thereto.

21. The apparatus of claim 20, wherein particular levels of the dynamically-defined hierarchy are dynamically enabled in response to user inputs.

22. The apparatus of claim 13, wherein said hierarchical cache is configured based on one or more user inputs relating to which of the one or more levels of the hierarchical cache are to be enabled for a current execution of the video motion process.

23. The apparatus of claim 13, wherein said hierarchical cache is accessed based on an integer portion and a fractional portion of a location corresponding to a reference frame used for the video motion process.
